(19) United States
(12) Patent Application Publication
(10) Pub. No.: US 2022/0201341 A1
(43) Pub. Date: Jun. 23, 2022

(54) METHOD, APPARATUS AND DEVICE FOR GAME LIVE-STREAMING

(71) Applicant: BEIJING DAJIA INTERNET INFORMATION TECHNOLOGY CO., LTD., Beijing (CN)

(72) Inventor: Xiao TANG, Beijing (CN)

(21) Appl. No.: 17/540,796

(22) Filed: Dec. 2, 2021

(30) Foreign Application Priority Data
Dec. 22, 2020 (CN) 202011526170.5

(51) Int. Cl. H04N 21/2187; A63F 13/86; H04N 21/478; A63F 13/87; A63F 13/79

(52) U.S. Cl. CPC H04N 21/2187; A63F 13/86; A63F 13/79; A63F 13/87; H04N 21/4781

(57) ABSTRACT

The present disclosure provides game live-streaming including receiving a collaborative gaming request from a live-streaming account, the collaborative gaming request including a collaborative account selected by the live-streaming account for collaborative gaming, and a collaborative game selected by the live-streaming account from one or more candidate games; invoking a cloud game service process to start and synchronize the collaborative game to a live-streaming interface, receiving a game operation instruction from the live-streaming account, and invoking the cloud game service process to update a video stream of the collaborative game to a live-streaming interface of the live-streaming account and a live-streaming interface of a non-collaborative account, and receiving a game operation instruction from the collaborative account, and invoking the cloud game service process to update a video stream of the collaborative game to a live-streaming interface of the collaborative account.

### CROSS-REFERENCE

The present disclosure is based on and claims priority under to Chinese Patent Application No. 202011526170.5, filed on Dec. 22, 2020, the entire content of which is incorporated herein by reference.

### TECHNICAL FIELD

The present disclosure relates to the field of information technology, in particular to live-streaming software involving computer or video games.

### BACKGROUND

With the rapid development of network technology, uploading videos to the terminals for live streaming through live-streaming platforms has been widely developed and adopted. Examples of live streaming include game live-streaming, talent live-streaming, beauty live-streaming, fashion live-streaming, etc., which have become a part of the daily life of the users. In game live-streaming, when the host logs into a host account on to the live-streaming platform to live stream content, the game host and the audience can communicate in order to select one or more audience accounts to enter a live-streaming room to collaborate with the host account in playing the game, thus improving audience participation.

### SUMMARY

In some arrangements, game live-streaming as applied to a live-streaming server includes receiving a collaborative gaming request from a live-streaming account and the collaborative gaming request comprising a collaborative account selected by the live-streaming account from one or more audience accounts, and a collaborative game selected by the live-streaming account from one or more candidate games, invoking a cloud game service process to start the collaborative game and synchronize the collaborative game to a live-streaming interface, receiving a first game operation instruction from the live-streaming account, and invoking the cloud game service process to update a video stream of the collaborative game to a live-streaming interface of the live-streaming account and a live-streaming interface of a non-collaborative account of the one or more audience accounts, and receiving a second game operation instruction from the collaborative account, and invoking the cloud game service process to update a video stream of the collaborative game to a live-streaming interface of the collaborative account.

In some arrangements, a device for game live-streaming includes a memory and a processor, where the memory is configured to store a computer program, and the processor is configured to read the computer program stored in the memory and to receive a collaborative gaming request from a live-streaming account and the collaborative gaming request including a collaborative account selected by the live-streaming account from one or more audience accounts for collaborative gaming, and a collaborative game selected by the live-streaming account from one or more candidate games, invoke a cloud game service process to start the collaborative game and synchronize the collaborative game to a live-streaming interface, receive a game operation instruction from the live-streaming account, and invoke the cloud game service process to update a video stream of the collaborative game a live-streaming interface of the live-streaming account and a live-streaming interface of a non-collaborative account of the one or more audience accounts, and receive a game operation instruction from the collaborative account, and invoke the cloud game service process to update a video stream of the collaborative game to a live-streaming interface of the collaborative account.

According to some arrangements, a non-transitory computer storage medium, stored thereon with a computer program that, executed by a processor, cause the processor to implement the method for game live-streaming as described herein.

### BRIEF DESCRIPTION OF THE DRAWINGS

FIG. 1 is a schematic diagram of an application scenario for game live-streaming provided by arrangements of the present disclosure.

FIG. 2 is a flowchart of a method for game live-streaming provided by arrangements of the present disclosure.

FIG. 3 is a schematic diagram of an interaction in a live-streaming game provided by arrangements of the present disclosure.

FIG. 4 is a schematic diagram of displaying setting options for the screening condition on a live-streaming interface provided by arrangements of the present disclosure.

FIG. 5 is a schematic diagram of a live-streaming interface of a candidate audience account provided by arrangements of the present disclosure.

FIG. 6 is a schematic diagram of recording operation information provided by arrangements of the present disclosure.

FIG. 7 is a schematic diagram of the specific content of the operation information provided by arrangements of the present disclosure.

FIG. 8 is a schematic diagram of a device for game live-streaming provided by arrangements of the present disclosure.

FIG. 9 is a schematic diagram of an apparatus for game live-streaming provided by arrangements of the present disclosure.

### DETAILED DESCRIPTION

The technical solutions in the arrangements of the present disclosure will be clearly and completely described below in conjunction with the accompanying drawings of the arrangements of the present disclosure. The described arrangements are only a part of the arrangements of the present disclosure, and not all of them. Based on the arrangements in the present disclosure, all other arrangements obtained by a person of ordinary skill in the art without making creative labor fall within the scope of protection of the present disclosure.

It should be noted that the arrangements described in the following example arrangements do not represent all arrangements that are consistent with the present disclosure. Rather, they are only examples of devices and methods that are consistent with some aspects of the present disclosure, as detailed in the appended claims.

Some of the terms used in arrangements of the present disclosure are explained and illustrated below for the understanding of one of ordinary skill in the art.

(1) The term “cloud game” in arrangements of the present disclosure, which can also be referred to as “game-on-demand,” is an online game based on cloud computing technology. A cloud game does not run in the game terminal where the game account is logged in. Instead the cloud server runs the game based on user input received at the game terminal and forwarded to the cloud server via a network and renders the game output or scene as a video and audio stream, transmitting the same to the player's game terminal through the network.

(2) The term “client” or “user terminal” in the present disclosure refers to a program that provides local services to the client and communicates with the server, except for some applications that run only locally, which are generally installed on ordinary clients and need to run in conjunction with the server side. With the development of the Internet, the common user terminals include web browsers for the World Wide Web, e-mail clients for sending and receiving e-mails, and instant messaging client software. For this type of application, there are servers and service programs in the network to provide the corresponding services, such as database services, e-mail services, etc. Thus, a specific communication connection needs to be established between the client and the server to ensure the normal operation of the application.

(3) The term “electronic device” in arrangements of the present disclosure may be a cell phone, a computer, a digital broadcast terminal, a messaging device, a game console, a tablet device, a medical device, a fitness device, a personal digital assistant, etc.

(4) The term “and/or” in arrangements of the present disclosure indicates that three relationships may exist. For example, A and/or B means only A, both A and B, and only B.

In order to clarify the purpose, technical solutions, and improvements of the present disclosure, the present disclosure is described below in detail in connection with the accompanying drawings. The described arrangements are only a part of the present disclosure, and not all of them. Based on the arrangements in this disclosure, all other arrangements obtained by a person of ordinary skill in the art without creative labor fall within the scope of protection of this disclosure.

In the existing scheme of collaborative gaming through game live-streaming rooms, after the host account logs into the live-streaming platform, the corresponding interface is called on the live-streaming platform to call and start the corresponding local game application (APP). The interface of that started game APP is live-streamed through the live-streaming platform. After the audience account logs into the live-streaming platform and teams up with the host on the live-streaming platform, the host account can notify the game ID of the host to the audience account, and the audience account looks up the game ID of the host after manually starting the corresponding game APP in the local client and initiate the collaborative gaming request. The host account selects the corresponding audience for collaborative gaming.

The above-mentioned scheme for collaborative gaming through game live-streaming rooms has shortcomings as follows.

(1) The host needs to initiate two APP software, including a live-streaming APP software used to log in to the live-streaming platform for game live-streaming, and a game APP software used for game data interaction, which is not convenient for operation.

(2) Audience users who log in to the live-streaming platform also need to use two APP software, including a live-streaming APP software used to log in to the live-streaming platform, and a game APP software used to find the host's game ID to request to join the game.

Based on (1) and (2) described above, the interaction of the game is conducted through the local game APP and the corresponding server when the operation for collaborative gaming is currently executed in the live-streaming room, which cannot realize the seamless switching between the live-streaming room and the game. The operation is quite complicated and the operation efficiency is low.

(3) There is a lack of appropriate regulatory channels for live-streaming platforms, and live-streaming platforms cannot obtain the collaborative game progress of each game account, so the live-streaming platforms cannot be managed effectively. For example, it is impossible to determine whether or not the host is actually playing a collaborative game with the audience after the audience makes an electronic transaction for collaborative gaming.

(4) There is no effective communication channel between the host and the audience, so the host may start the game before the audience's application for collaborative gaming is successful, or the audience has problems with the game, but the host can only wait anxiously without understanding the audience's situation.

Based on the above-mentioned problems, arrangements of the present disclosure relates to game live-streaming that can directly invoke cloud games in the live-streaming interface to achieve seamless switching between the live-streaming room and the game. Implementations of the game live-streaming provided by arrangements of the present disclosure are described below.

### Arrangement I

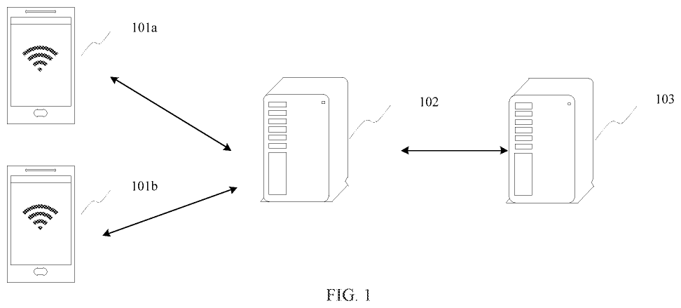

As illustrated in FIG. 1, arrangements of the present disclosure provide a schematic diagram of an application scenario for game live-streaming. The application scenario includes followings.

A live client 101a is configured for a live-streaming account to log in and display a live-streaming interface, send a collaborative gaming request, display a live-streaming interface of the collaborative game, send a game operation instruction through the live-streaming interface, and display an updated video stream of the collaborative game in the live-streaming interface.

An on-demand client 101b is configured for an audience account to log in and watch the live-streaming interface of the live-streaming account, send a collaborative gaming request through the live-streaming interface when the audience account wants to participate in the game, send a game operation instruction through the live-streaming interface and display an updated video stream of the collaborative game corresponding to the interface in response to the audience account being selected as a collaborative account, or display the video stream of the game corresponding to the live-streaming account in response to the audience account being not selected as a collaborative account by the live-streaming account.

A live-streaming server 102 is configured to receive the collaborative gaming request sent by the live-streaming account, invoke a cloud game service process to start the collaborative game and synchronize it to the live-streaming interface, receive the game operation instruction sent by the live-streaming account and call the cloud game service process to update the video stream of the collaborative game corresponding to the live-streaming interface of the live-streaming account and a live-streaming interface of a non-collaborative account of the audience accounts, and receive the game operation instruction sent by the collaborative account and invoke the cloud game service process to update the video stream of the collaborative game corresponding to a live-streaming interface of the collaborative account.

A game service process server 103 is configured to interact with the live-streaming server, start the collaborative game and send the video stream of the collaborative game to the live-streaming server under the call of the live-streaming server, receive the game operation instruction from the live-streaming server sent by the live-streaming account, and update the video stream of the collaborative game corresponding to the live-streaming interface of the live-streaming account and the live-streaming interface of the non-collaborative account of the audience accounts; and receive the game operation instruction from the live-streaming server sent by the collaborative account, and update the video stream of the collaborative game corresponding to the live-streaming interface of the collaborative account.

It should be noted that the operations performed by the live-streaming account/audience account/collaborative account/non-collaborative account described below actually are operations performed by the client to which the account is logged in (such as above-mentioned live client 101a, on-demand client 101b, etc.).

The above game service process server 103 and live-streaming server 102 may be different servers or the same server.

In arrangements of the present disclosure, the live client 101a and the on-demand client 101b are electronic devices used by the user, which may be personal computers, cell phones, tablet computers, notebooks, e-book readers, and other computer devices with computing power and running instant messaging software and websites or running social software and websites. Each terminal device is connected to a server through a wireless network, and the server may be an independent physical server, or a server cluster or distributed system composed of multiple physical servers, or a cloud server that provides basic cloud computing services such as cloud services, cloud database, cloud computing, cloud function, cloud storage, network services, cloud communication, middleware services, domain name services, security services, Content Delivery Network (CDN), big data and artificial intelligence platforms.

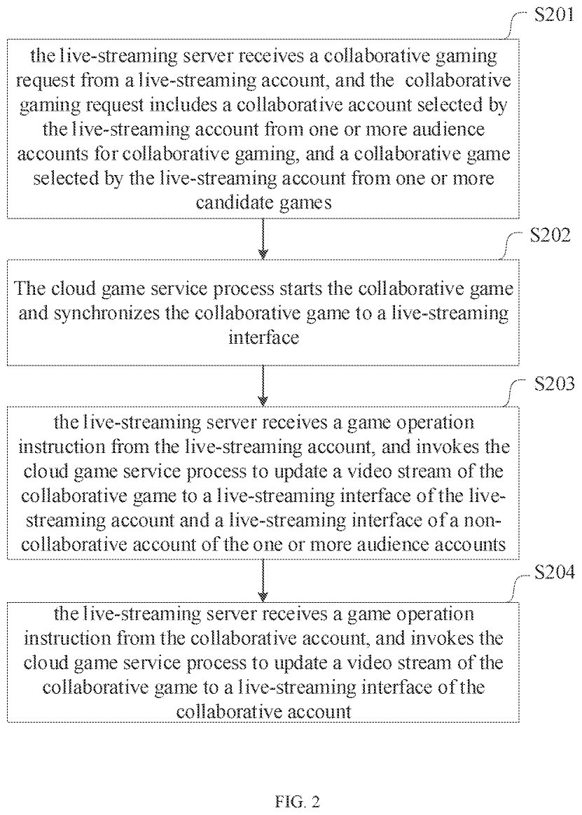

As illustrated in FIG. 2, arrangements of the present disclosure provide a flowchart of a method for game live-streaming. The method is applied to a live-streaming server, and the method includes as follows.

At S201, the live-streaming server receives a collaborative gaming request from a live-streaming account. The collaborative gaming request includes a collaborative account selected by the live-streaming account from one or more audience accounts for collaborative gaming, and a collaborative game selected by the live-streaming account from one or more candidate games.

It should be noted that the above collaborative account is selected by the live-streaming account among the audience accounts that have indicated the intention to collaborate on the game and meet the collaborative gaming requirements, i.e. it is obtained by the bi-directional selection of the live-streaming account and the audience account.

The number of collaborative accounts mentioned above may be one or more.

The above-mentioned candidate games may include any games that can be implemented in the form of cloud games, and the live-streaming account picks a collaborative game among the candidate games.

In some implementations, before receiving the collaborative gaming request from the live-streaming account, the method further includes displaying a live-streaming interface of the one or more candidate games in response to receiving a live-streaming request from the live-streaming account and displaying information of an audience account on the live-streaming interface in response to receiving a request for watching the live-streaming from the audience account.

It should be noted that the above-mentioned displaying the live-streaming interface of the one or more candidate games on the live-streaming server may include followings.

(1) The live-streaming server, through interaction with the cloud game service process server, invokes the cloud game service process to start one or more candidate games and update the corresponding video streams, and the live-streaming server directly displays the video streams of the one or more candidate games.

(2) The live-streaming server, without interacting with the cloud game service process server, only displays names or icons of the one or more candidate games on the live-streaming interface.

Here, the live-streaming account is the account that performs live-streaming operation through the live-streaming client on the live-streaming platform. Live-streaming operation includes, but is not limited to, the live-streaming account live-streaming a game which the host is playing in collaboration with the audience account watching the live-streaming, the live-streaming account live-streaming a game which the host is playing alone or with other accounts that are not audience of the game.

The live-streaming request may be sent from the live-streaming account by any suitable mechanisms, e.g., triggering a live button, timing start of the live streaming, etc., which will not be elaborated here.

The live-streaming interface displays the live-streaming content of the live-streaming account, the candidate games, and information of the audience account, etc.

The above-mentioned display of the information of the audience account on the live-streaming interface can be achieved, for example, by any suitable mechanisms of displaying the audience account icon and/or the audience account name and/or the prompt message that the audience account enters the live-streaming room of the live-streaming account.

Through the above implementations, the candidate games and the information of the audience account are displayed on the live-streaming interface, which facilitates the audience account to visually determine whether they are willing to participate in the game, as well as facilitates the live-streaming account to visually determine the information of the audience watching its own live stream, which is conducive to the subsequent promotion of the collaborative game.

At S202, the live-streaming server invokes a cloud game service process to start the collaborative game and synchronize the collaborative game to a live-streaming interface.

Through the interaction between the live-streaming server and the cloud game server process, the live-streaming server invokes the cloud game service process to start the collaborative game.

Specifically, the live-streaming server may send a call request to the cloud game service process server. The call request carries information for determining the desired cloud game to be called, such as the name of the cloud game, the code of the cloud game, etc. The cloud game service process server may start the corresponding cloud game based on the information carried in the call request that can determine the desired cloud game to be called.

The above-mentioned synchronization of the collaborative game to the live-streaming interface refers to the synchronization of the collaborative game to the live-streaming interface of the live-streaming account, the live-streaming interface of the collaborative account, and the live-streaming interface of the non-collaborative account in the audience accounts. Here, the live-streaming account and the collaborative account have an operation authority to operate the collaborative game.

The non-collaborative account does not have the operation authority and can only watch the live video stream and the corresponding operations of the live-streaming account.

At S203, the live-streaming server receives a game operation instruction from the live-streaming account, and invokes the cloud game service process to update a video stream of the collaborative game to a live-streaming interface of the live-streaming account and a live-streaming interface of a non-collaborative account of the one or more audience accounts.

In response to receiving the game operation instruction sent by the live-streaming account, the live-streaming server sends the game operation instruction to the cloud game service process server. The cloud game service process server invokes the cloud game service process to perform, according to the received game operation instruction, the corresponding operation to update the video stream of the collaborative game.

The above-mentioned invoking the cloud game service process to update the video stream of the collaborative game to the live-streaming interface of the live-streaming account and the live-streaming interface of the non-collaborative account of the audience accounts can be performed by the cloud game service process server actively sending the video stream of the collaborative game to the live-streaming server, and the live-streaming server then pushing the video stream to the live-streaming interface of the live-streaming account and the live-streaming interface of the non-collaborative account.

In some arrangements, the live-streaming server to retrieve the video stream of the collaborative game at the cloud game service process server and push the video stream to the live-streaming interface of the live-streaming account and the live-streaming interface of the non-collaborative account.

The above-mentioned game operation instruction includes instructions for logging in and forming a team before the start of a collaborative game, and instructions after the start of the game.

The non-collaborative account does not have the authority to issue the game operation instructions and can only watch the live-streaming account's operations.

At S204, the live-streaming server receives a game operation instruction from the collaborative account, and invokes the cloud game service process to update a video stream of the collaborative game to a live-streaming interface of the collaborative account.

In response to receiving the game operation instruction sent by the collaborative account, the live-streaming server sends the game operation instruction to the cloud game service process server. The cloud game service process server invokes the cloud game service process to perform, according to the received game operation instruction, the corresponding operation to update the video stream of the collaborative game.

The above-mentioned invoking the cloud game service process to update the video stream of the collaborative game to the live-streaming interface of the collaborative account can be performed by the cloud game service process server actively sending the video stream of the collaborative game to the live-streaming server, and the live-streaming server then pushing the video stream to the live-streaming interface of the collaborative account.

In some arrangements, the live-streaming server to retrieve the video stream of the collaborative game at the cloud game service process server and push the video stream to the live-streaming interface of the collaborative account.

Through the above scheme for game live-streaming, the direct invocation of live-streaming server to cloud game service process server is realized, and the live-streaming account and collaborative account can invoke cloud game directly in the live-streaming interface to realize the seamless switching of live-streaming room and game, which is simple to operate and improves the operation efficiency and user experience.

In some implementations, receiving the game operation instruction from the live-streaming account or the collaborative account, and invoking the cloud game service process to update the video stream of the collaborative game, includes receiving the game operation instruction from the live-streaming account or the collaborative account, sending the game operation instruction to the cloud game service process, to enable the cloud game service process to perform, based on the received game operation instruction, an operation corresponding to the game operation instruction, to update the video stream of the collaborative game, and obtaining the updated video stream of the collaborative game from the cloud game service process.

It should be noted that, the cloud game service process receives the game operation instruction from the live-streaming account and the game operation instruction from collaborative account in real time, both game operations having an impact on the collaborative game, and being not separated.

The above-mentioned update of the video stream of the collaborative game means to present the live-streaming account or the collaborative account the screen of the corresponding area in which respective operations are performed. For example, during the collaborative gaming, the live-streaming account performs an operation in the first area and the collaborative account performs an operation in the second area. Then the video stream corresponding to the first area is displayed for the live-streaming account and the video stream corresponding to the second area is displayed for the collaborative account.

Through the above implementations, the interaction between the live-streaming server and the cloud game server is defined, which clearly realizes that the live-streaming server receives the game operation instruction from the live-streaming account or the collaborative account and invokes the cloud game service process to update the video stream of the collaborative game.

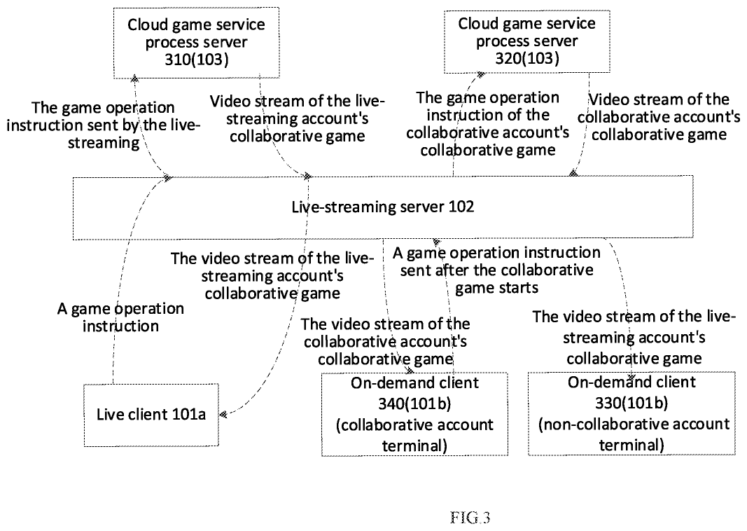

As illustrated in FIG. 3, the arrangements of the present disclosure provide a schematic diagram of an interaction in a game live streaming.

The live-streaming account on the live client 101a sends a game operation instruction. The live-streaming server 102 receives the game operation instruction and sends it to the cloud game service process server 310 (103). The cloud game service process server 310 (103) receives the game operation instruction of the live-streaming account, updates the video stream of the live-streaming account's collaborative game, and further updates the video stream to the live-streaming interfaces of the live-streaming account and the non-collaborative account on the on-demand client 330 (101b) (non-collaborative account terminal) via the live-streaming server 102.

After the collaborative game starts, the collaborative account on the on-demand client 340 (101b) (collaborative account terminal) sends a game operation instruction. The live-streaming server 102 receives the game operation instruction and sends it to the cloud game service process server 320 (103). The cloud game service process server 320 (103) receives the game operation instruction of the collaborative account, updates the video stream of the collaborative account's collaborative game, and further updates the video stream to the live-streaming interface of the collaborative account via the live-streaming server 102.

It should be noted that some entities may be added or deleted in FIG. 3, and not all entities are shown in this figure. For example, the above on-demand client (collaborative account terminal) is example and may refer to one or more collaborative account terminals with no limit on the number of collaborative account terminals; and the above on-demand client (non-collaborative account terminal) is only example and may refer to one or more non-collaborative account terminals with no limit on the number of non-collaborative account terminals.

The cloud game service process server that receives the game operation instruction from the live-streaming account and the cloud game service process server that receives the game operation instruction from the collaborative account may be one cloud game service process server or different cloud game service process servers.

In the technical solution for game live-streaming known so far, the live-streaming account cannot get the information about the audience accounts who have the desire to collaborate in the game. In addition, the live-streaming account is also unable to select the collaborative account directly among the audience accounts that have the will to the collaborative game through the live-streaming room. Thus, in view of the above problems, the present disclosure provides the following implementation.

In some implementations, before receiving the collaborative gaming request from the live-streaming account, the method further includes obtaining a screening condition from the live-streaming account, where the screening condition is configured for screening out the collaborative account, screening out at least one candidate audience account matching the screening condition from the one or more audience accounts, and displaying, on the live-streaming interface, any of the at least one candidate audience account as a candidate collaborative account in response to receiving a collaborative gaming request from the any of the at least one candidate audience account, to enable the live-streaming account to determine the collaborative account from the candidate collaborative account.

It should be noted that the following three steps may be required to determine the collaborative account.

(1) The live-streaming account sets the screening condition(s), and the live-streaming server screens out, from the audience accounts, the candidate audience account(s) that meet the screening condition(s) according to the obtained screening condition(s).

(2) Among the above candidate audience account(s), the one, who determines that he or she has the will to collaborative the game, sends a collaborative gaming request.

(3) The live-streaming account selects the final collaborative account(s) from the candidate audience account(s) that sent the collaborative gaming request.

The above-mentioned display of any of the at least one candidate audience account as a candidate collaborative account on the live-streaming interface may be in real time, or the candidate collaborative accounts may be displayed after sorting according to predetermined rules. For example, priority is given to displaying the candidate collaborative accounts with higher game account level, or, priority is given to displaying the candidate collaborative accounts with higher interest in the live-streaming account.

Through the above implementation, the live-streaming server performs preliminary screening of audience accounts, receives game requests from some of the preliminary screened audience accounts, and then displays the audience accounts that sent the game requests on the live-streaming interface for the live-streaming account to select the collaborative accounts. Through a bi-directional selection of the live-steaming account and the audience accounts, the collaborative account can be determined.

In some implementations, obtaining the screening condition from the live-streaming account includes receiving a setting request from the live-streaming account, and displaying setting options for the screening condition on the live-streaming interface in response to the setting request and receiving, from the live-streaming account, editing information for the setting options, and generating the screening condition based on the editing information.

It should be noted that the above operation of sending the setting request from the live-streaming account can be conducted by any suitable mechanisms of sending a request, e.g., tapping a button, triggering an icon, voice command, etc., which is not limited in arrangements of the present disclosure.

The above setting options for the screening condition can be presented in the following form.

(1) The form of options, showing the corresponding options, which can be checked or adjusted in number by the live-streaming account.

(2) The form of filling, which the live-streaming account draws up its own screening conditions and sets them in the form of text or voice.

(3) The form of the combination of options and filing, providing basic options for the live-streaming account to select, and the live-streaming account can also additionally add its own set of conditions.

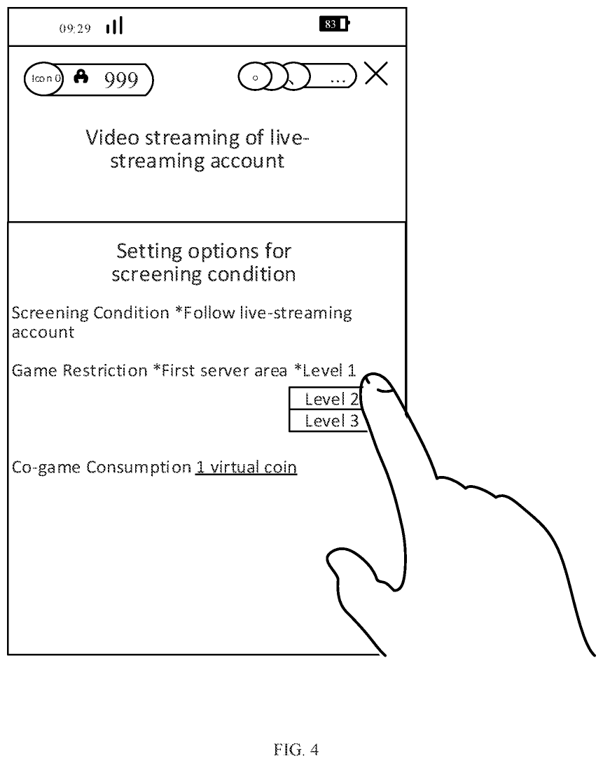

As illustrated in FIG. 4, arrangements of the present disclosure provide a schematic diagram of displaying the setting options for the screening condition on a live-streaming interface.

The setting options shown in FIG. 4 are in the form of the combination of options and filling, where “Screening Condition” and “Game Restriction” include options. The live-streaming account can trigger the above “Screening Condition” and “Game Restriction” to select the corresponding content, for example, in FIG. 4, the live-streaming account is selecting the game level in the “Game Restriction” option, and may choose among the options “Level 1”, “Level 2” and “Level 3” provided in the game level according to the specific needs. The “Co-game Consumption” option is in the form of filling, and the live-streaming account can fill in according to the specific needs.

Through the above implementations, the live-streaming account sets the editing information through the setting options for the screening condition, and the live-streaming server generates the screening condition configured for screening out the collaborative account based on the editing information, which provides the necessary screening conditions for the collaborative account screening.

In some implementations, the above screening condition configured for screening out the collaborative account includes any one or more of a degree of an audience account's interest in the live-streaming account being greater than a predetermined value, an electronic trading behavior of an audience account complying with an electronic trading rule established by the live-streaming account, or a game account classification of an audience account belonging to a game account classification of the collaborative game selected by the live-streaming account.

The degree of the audience account's interest in the live-streaming account is reflected in that: the audience account follows the live-streaming account, the audience account gives virtual gifts for the live-streaming account with a value exceeding a predetermined value (e.g. the value of a single gift exceeds 300 virtual coins or the cumulative value of virtual gifts exceeds 5000 virtual coins) or the time that the audience account watches the live streaming of the live-streaming account is greater than the preset threshold (e.g. the cumulative time spent watching the live broadcast of the live-streaming account is greater than 24 hours), or the audience account's history of watching the live broadcast of the live-streaming account is greater than the preset threshold (e.g. the cumulative number of times of watching the live broadcast of the live-streaming account is more than 30 times).

The electronic trading behavior of the audience account complying with the electronic trading rule established by the live-streaming account includes that the value of the virtual currency consumed by the audience account in the live room of the live-streaming account reaches a preset value (e.g. consumes more than 4000 virtual coins in the live room of the live-streaming account), or the audience account pays for the collaborative game in the live room of the live-streaming account (e.g. consumes 1 virtual coin to pay for the collaborative game).

The game account classification of the audience account includes: the level of the game account of the audience account and the server where the game account of the audience account is located.

The above implementation describes the specifics of the above screening condition for the collaborative account and refines the operation of the live-streaming server to generate the screening condition for the collaborative account based on the editing information.

In some implementations, receiving the collaborative gaming request from any of the at least one candidate audience account, includes displaying a trigger icon corresponding to the collaborative gaming request on a live-streaming interface of the candidate audience account, and receiving the collaborative gaming request from the candidate audience account upon operation on the trigger icon.

It should be noted that only audience accounts that meet the condition for screening out the collaborative account, i.e. the above-mentioned candidate audience accounts, will have the trigger icon corresponding to the collaborative gaming request displayed on their live-streaming interfaces.

The trigger icon corresponding to the collaborative gaming request may be a simple icon or button, or may be a page displaying information and/or a page for candidate audience accounts to fill in information.

It should be noted that the collaborative gaming request carries the account information and the game account information of the candidate collaborative audience account.

Through above implementations, the specific operation of receiving the collaborative gaming request from any of the at least one candidate audience account is provided, to provide the necessary conditions for the live-streaming account to select a collaborative game account from the candidate collaborative audience accounts.

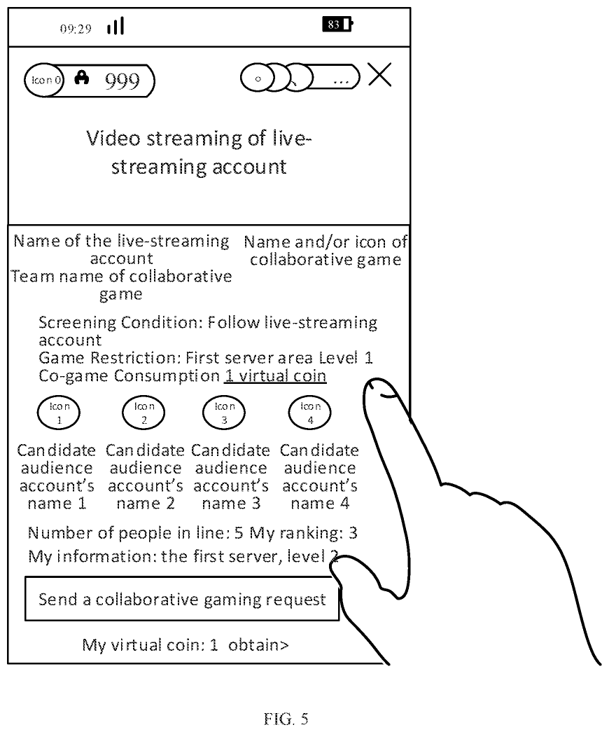

As illustrated in FIG. 5, arrangements of the present disclosure provide a schematic diagram of a live-streaming interface of a candidate audience account. This figure shows the interface for sending a collaborative gaming request by the candidate audience account.

The interface for sending the collaborative gaming request displays: (1) the name and/or icon of the live-streaming account; (2) the name and/or icon of the collaborative game selected by the live-streaming account; (3) the team name of the selected collaborative game of the live-streaming account; (4) the screening conditions set by the live-streaming account; (5) the names and/or icons of the candidate audience accounts; (6) the number of candidate collaborative game accounts, and the rank of the candidate audience account in the candidate collaborative accounts; (7) an information column for the candidate audience account to fill in and modify game account information; (8) a button to send a collaborative game request; and (9) information about the electronic trading behavior of the candidate audience account and an entrance to perform the electronic trading behavior.

“Icon 0” shown in FIG. 5 is the icon of the live-streaming account and “Icon 1” to “Icon 4” are the icons of the collaborative accounts.

In the technical solution of live game broadcasting known so far, there is a lack of effective communication channels between the host and the audiences, and it may happen that the host has already started the game before the audiences apply for the collaborative game successfully, or the audiences encounters problems with the game, and the host can only wait anxiously and cannot understand the situation of the audience. In view of above problems, the present disclosure provides an implementation below.

In some implementations, after receiving the collaborative gaming request from the live-streaming account, the method further includes establishing a voice connection between the live-streaming account and the collaborative account.

Through above implementation, by establishing the voice connection between the live-streaming account and the collaborative account, an effective communication channel is established between the live-streaming account and the collaborative account to know each other's situation and status in time.

In the technical solution for game live-streaming known so far, the live-streaming platform lacks a suitable supervision channel, and the live-streaming platform cannot obtain the progress of each game account's collaborative game, so it cannot effectively manage the collaborative games, for example, it cannot determine whether the host is actually collaborating with the audience after the audience has made an electronic transaction for collaborative gaming.

In view of above problem, the present disclosure provides an implementation below.

According to the invocation of the cloud game service process, the operation information of the live-streaming account and each collaborative account for collaborative gaming is recorded. The operation information includes time to start the collaborative game, time to end the collaborative game, and a reason to end the collaborative game.

It should be noted that the way to record the operation information includes: text, video, voice, etc. Any way that can realize the supervision of the operation information of the live-streaming account and the collaborative account can be applied to the present disclosure.

The above operation information can be viewed directly in the live-streaming interface or live-streaming server during the process of the collaborative game, and can also be queried through the live-streaming server after the collaborative game is over.

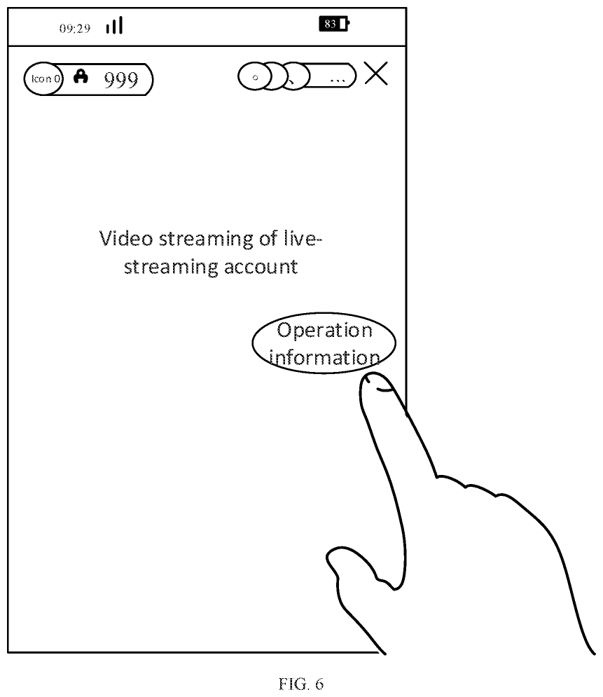

As illustrated in FIG. 6, the present disclosure provides a schematic diagram of recording operation information.

In FIG. 6, a floating icon for the operation information is displayed on the live-streaming interface. The live-streaming account and audience account can trigger the icon to view specific operation information.

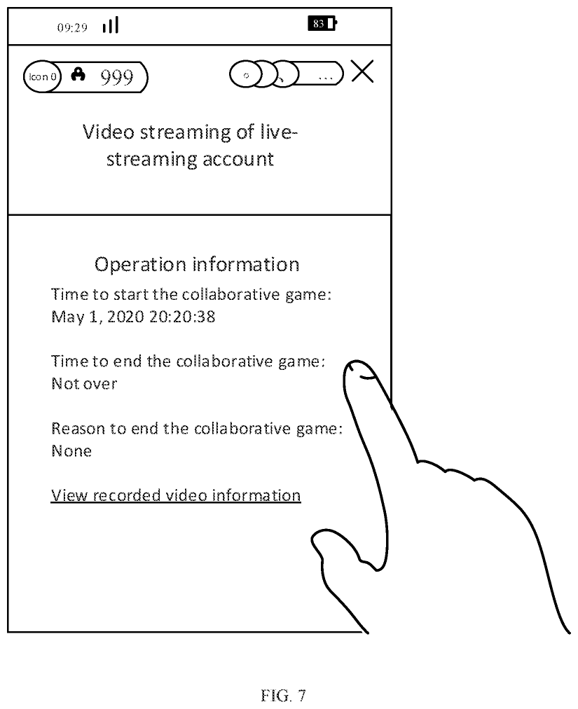

As illustrated in FIG. 7, arrangements of the present disclosure provide a schematic diagram of the specific content of the operation information.

In FIG. 7, the details of the operation information include: the time to start the collaborative game, the time to end the collaborative game, and the reason to end the collaborative game, and the recorded video information.

Through above implementations, by recording the operation information of the live-streaming account and each collaborative account for collaborative gaming, in some arrangements, the collaborative gaming of the live-streaming account and the collaborative account are monitored or supervised to determine whether the live-streaming account has satisfied the demand for collaborative gaming of the collaborative account during the game is in progress or after the game is completed.

The present disclosure further provides an implementation of the live-streaming account closing the cloud game or stopping collaborative gaming with the selected collaborative account, which includes receiving a game close instruction from the live-streaming account, releasing the invoked cloud game service process, and displaying a live-streaming interface of the one or more candidate games, or receiving, from the live-streaming account, an instruction to stop collaborative gaming with the collaborative account, and updating the collaborative account as a non-collaborative account.

The live-streaming account can restore the video stream of the cloud game to the video stream of the live-streaming interface by sending the game close instruction.

The live-streaming account can also choose to stop collaborative gaming with one or more specified collaborative accounts, and then the specified collaborative accounts are updated as non-collaborative accounts, and the video stream of the live-streaming interface switches to the source game video stream of the live-streaming account.

Through above implementations, the live-streaming account can close the cloud game directly through the live-streaming interface, or end the collaboration of the game with the specified collaborative accounts.

### Arrangement II

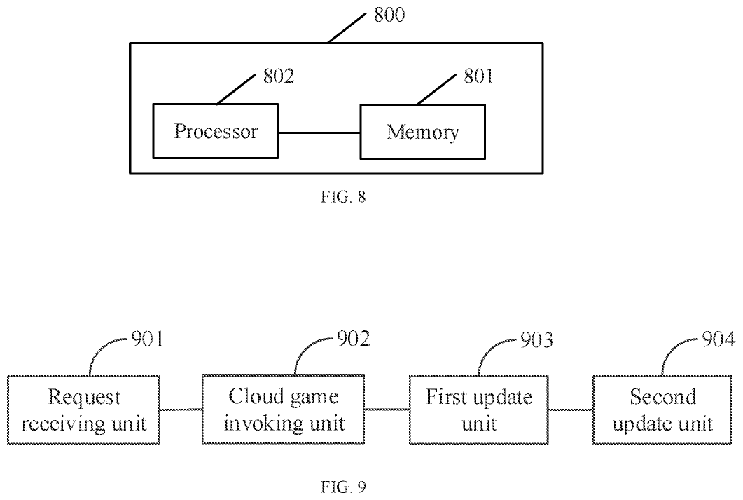

Arrangements of the present disclosure provide a device 800 for game live-streaming, including a memory 801 and a processor 802, as shown in FIG. 8, where the memory is configured to store a computer program, and the processor is configured to read the computer program stored in the memory and to receive a collaborative gaming request from a live-streaming account and the collaborative gaming request including: a collaborative account selected by the live-streaming account from one or more audience accounts for collaborative gaming, and a collaborative game selected by the live-streaming account from one or more candidate games, invoke a cloud game service process to start the collaborative game and synchronize the collaborative game to a live-streaming interface, receive a game operation instruction from the live-streaming account, and invoking the cloud game service process to update a video stream of the collaborative game to a live-streaming interface of the live-streaming account and a live-streaming interface of a non-collaborative account of the one or more audience accounts, and receive a game operation instruction from the collaborative account, and invoking the cloud game service process to update a video stream of the collaborative game to a live-streaming interface of the collaborative account.

In some arrangements, the processor is further configured to receive a game close instruction from the live-streaming account, release the invoked cloud game service process, and display a live-streaming interface of the one or more candidate games, or receive, from the live-streaming account, an instruction to stop collaborative gaming with the collaborative account, and update the collaborative account as a non-collaborative account.

In some implementations, prior to the processor receiving the collaborative gaming request from the live-streaming account, the processor is further configured to display a live-streaming interface of the one or more candidate games in response to receiving a live-streaming request from the live-streaming account, and display information of an audience account on the live-streaming interface in response to receiving a request for watching the live-streaming from the audience account.

In some implementations, prior to the processor receiving the collaborative gaming request from the live-streaming account, the processor is further configured to obtain a screening condition from the live-streaming account, where the screening condition is configured for screening out the collaborative account, screen out at least one candidate audience account matching the condition from the one or more audience accounts, and display, on the live-streaming interface, any of the at least one candidate audience account as a candidate collaborative account in response to receiving a collaborative gaming request from the any of the at least one candidate audience account, to enable the live-streaming account to determine the collaborative account from the candidate collaborative account.

In some implementations, the screening condition includes any one or more of a degree of an audience account's interest in the live-streaming account being greater than a predetermined value, an electronic trading behavior of an audience account complying with an electronic trading rule established by the live-streaming account, a game account classification of an audience account belonging to a game account classification of the collaborative game selected by the live-streaming account.

In some implementations, the processor is configured to obtain the screening condition from the live-streaming account by receiving a setting request from the live-streaming account, and displaying setting options for the screening condition on the live-streaming interface in response to the setting request, and receiving, from the live-streaming account, editing information for the screening condition setting options, and generating the screening condition based on the editing information.

In some implementations, the process is configured to receive the collaborative gaming request from the any of the at least one candidate audience account by displaying a trigger icon corresponding to the collaborative gaming request on a live-streaming interface of the candidate audience account, and receiving the collaborative gaming request from the candidate audience account upon operation on the trigger icon.

In some implementations, the processor is further configured to receive the game operation instruction from the live-streaming account or the collaborative account, and invokes the cloud game service process to update the corresponding video stream of the collaborative game, by receiving the game operation instruction from the live-streaming account or the collaborative account, sending the game operation instruction to the cloud game service process, to enable the cloud game service process to perform, based on the received game operation instruction, an operation corresponding to the game operation instruction, to update the video stream of the collaborative game, and obtaining the updated video stream of the collaborative game from the cloud game service process.

In some implementations, the processor is further configured to record operation information of the live-streaming account and the collaborative account for collaborative gaming based on the invoking the cloud game service process, where the operation information includes: time to start the collaborative game, time to end the collaborative game, and a reason to end the collaborative game.

In some implementations, the processor is further configured to establish a voice connection between the live-streaming account and the collaborative account in response to receiving the collaborative gaming request from the live-streaming account.

Arrangements of the present disclosure provide an apparatus for game live-streaming, as shown in FIG. 9, including a request receiving unit 901, configured to receive a collaborative gaming request from a live-streaming account, the collaborative gaming request including a collaborative account selected by the live-streaming account from one or more audience accounts for collaborative gaming, and a collaborative game selected by the live-streaming account from one or more candidate games. The apparatus further includes a cloud game invoking unit 902, configured to invoke a cloud game service process to start the collaborative game and synchronize the collaborative game to a live-streaming interface. The apparatus further includes a first update unit 903, configured to receive first a game operation instruction from the live-streaming account, and invoke the cloud game service process to update a video stream of the collaborative game to a live-streaming interface of the live-streaming account and a live-streaming interface of a non-collaborative account of the one or more audience accounts. The apparatus further includes a second update unit 904, configured to receive second a game operation instruction from the collaborative account, and invoke the cloud game service process to update a video stream of the collaborative game to a live-streaming interface of the collaborative account.

In some implementations, the apparatus is further configured to receive a game close instruction from the live-streaming account, release the invoked cloud game service process, and display a live-streaming interface of the one or more candidate games, or receive, from the live-streaming account, an instruction to stop collaborative gaming with the collaborative account, and update the collaborative account as a non-collaborative account.

In some implementations, prior to receiving the collaborative gaming request from the live-streaming account, the request receiving unit is further configured to display a live-streaming interface of the one or more candidate games in response to receiving a live-streaming request from the live-streaming account, and display information of an audience account on the live-streaming interface in response to receiving a request for watching the live-streaming from the audience account.

In some implementations, prior to receiving the collaborative gaming request from the live-streaming account, the request receiving unit is further configured to obtain a screening condition from the live-streaming account, where the screening condition is configured for screening out the collaborative account, screen out at least one candidate audience account matching the screening condition from the one or more audience accounts, and display, on the live-streaming interface, any of the at least one candidate audience account as a candidate collaborative account in response to receiving a collaborative gaming request from the any of the at least one candidate audience account, to enable the live-streaming account to determine the collaborative account from the candidate collaborative account.

In some implementations, the screening condition includes any one or more of a degree of an audience account's interest in the live-streaming account being greater than a predetermined value, an electronic trading behavior of an audience account complying with an electronic trading rule established by the live-streaming account, a game account classification of an audience account belonging to a game account classification of the collaborative game selected by the live-streaming account.

In some implementations, the request receiving unit is further configured to obtain the screening condition from the live-streaming account by receiving a setting request from the live-streaming account, and displaying setting options for the screening condition on the live-streaming interface in response to the setting request, and receiving, from the live-streaming account, editing information for the setting options, and generating the screening condition based on the editing information.

In some implementations, the request receiving unit is configured to receive the collaborative gaming request from the any of the at least one candidate audience account by displaying a trigger icon corresponding to the collaborative gaming request on a live-streaming interface of the candidate audience account, and receiving the collaborative gaming request from the candidate audience account upon operation on the trigger icon.

In some implementations, the first update unit is configured to receive the game operation instruction from the live-streaming account and invokes the cloud game service process to update the video stream of the collaborative game, or the second update unit is configured to receive the game operation instruction from the collaborative account and invokes the cloud game service process to update the video stream of the collaborative game, by receiving the game operation instruction from the live-streaming account or the collaborative account, sending the game operation instruction to the cloud game service process, to enable the cloud game service process to perform, based on the received game operation instruction, an operation corresponding to the game operation instruction, to update the video stream of the collaborative game; and obtaining the updated video stream of the collaborative game from the cloud game service process.

In some implementations, the apparatus is further configured to record operation information of the live-streaming account and the collaborative account for collaborative gaming based on the invoking the cloud game service process, where the operation information comprises: time to start the collaborative game, time to end the collaborative game, and a reason to end the collaborative game.

In some implementations, the request receiving unit is further configured to establish a voice connection between the live-streaming account and the collaborative account in response to receiving the collaborative gaming request from the live-streaming account.

The present disclosure also provides a computer program medium with a computer program stored thereon, which when executed by a processor executes the steps of the method for game live-streaming provided in Arrangement I above.

In the arrangements provided by the present disclosure, it should be understood that the disclosed systems, devices and methods, may be implemented in other ways. For example, the device arrangements described above are merely schematic. For example, the division of the modules, which is only a logical functional division, can be divided in other ways when actually implemented, e.g., multiple modules or components can be combined or can be integrated into another system, or some features can be ignored, or not implemented.

Furthermore, the coupling or direct coupling or communication connections shown or described with each other can be indirect coupling or communication connections through some interfaces, devices or modules, which may be in electrical, mechanical or other forms.

The modules illustrated as separate components may or may not be physically separated, and the components displayed as modules may or may not be physical modules, i.e., they may be located in one place, or may also be distributed over a plurality of network modules. Some or all of these modules may be selected according to the actual needs of the modules to achieve the purpose of the present disclosure.

Moreover, the various functional modules in various arrangements of the present disclosure may be integrated in a single processing module, or each module may be physically present separately, or two or more modules may be integrated in a single module. The integrated modules can be implemented either in the form of hardware or software functional modules. When implemented as software function modules and sold or used as stand-alone products, the integrated modules can be stored in a computer-readable storage medium.

The above arrangements may be implemented in whole or in part by software, hardware, firmware, or any combination thereof. When implemented using software, it may be implemented in whole or in part in the form of a computer program product.

The computer program product includes one or more computer instructions. When the computer instructions are loaded and executed on a computer, all or part of them produce a process or function as described in accordance with arrangements of the present disclosure. The computer may be a general purpose computer, a specialized computer, a computer network, or other programmable device. The computer instructions may be stored in a computer-readable storage medium or transmitted from one computer-readable storage medium to another computer-readable storage medium, e.g., the computer instructions may be transmitted from one website site, computer, server, or data center to another via wired (e.g., coaxial cable, fiber optic, digital subscriber line (DSL)) or wireless (e.g., infrared, wireless, microwave, etc.) communication methods. The computer-readable storage medium may be any available media that a computer can store or a data storage device such as a server, data center, etc. that contains one or more available media integrated. The available media may be magnetic media, (e.g., floppy disk, hard disk, magnetic tape), optical media (e.g., DVD), or semiconductor media (e.g., solid state disk (SSD)), etc.

The above technical solutions provided in this disclosure have been described in detail, and specific examples have been applied in this disclosure to illustrate the principles and implementation of this disclosure. The above description of the arrangements is only for helping to understand the method of the present disclosure and its core ideas; at the same time, for a person of ordinary skill in the art, according to the ideas of this disclosure, there will be changes in the specific implementation and application scope. In view of above, the contents of this description should not be construed as a limitation of the present disclosure.

It should be understood by those skilled in the art that arrangements of the present disclosure may be provided as methods, systems, or computer program products. Accordingly, the present disclosure may be implemented in the form of an entirely hardware arrangement, an entirely software arrangement, or a combination of software and hardware arrangements. Further, the present disclosure may be implemented by employing a computer program product implemented on one or more computer-usable storage media (including, but not limited to, disk memory, CD-ROM, optical memory, etc.) containing computer-usable program code therein.

The present disclosure is described with reference to flowcharts and/or block diagrams of methods, devices (systems), and computer program products according to the present disclosure. It is to be understood that each process and/or box in the flowchart and/or block diagram, and the combination of processes and/or boxes in a flowchart and/or block diagram, may be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes in the flowchart and/or one box or multiple boxes in the block diagram.

These computer program instructions may also be stored in a computer readable memory capable of directing a computer or other programmable data processing device to operate in a particular manner such that the instructions stored in the computer readable memory produce an article of manufacture comprising an instruction device that implements the functions specified in one or more processes of the flowchart and/or one or more boxes of the block diagram.

These computer program instructions may also be loaded onto a computer or other programmable data processing device, enabling a series of operational steps to be executed on the computer or other programmable device to produce a computer-implemented process, so that the instructions executed on the computer or other programmable device provide steps for implementing the functions specified in one or more processes of the flowchart and/or one or more boxes of the block diagram.

Obviously, a person skilled in the art can make various modifications and variations of the present disclosure without departing from the spirit and scope of the present disclosure. Thus, if these modifications and variations of the present disclosure are within the scope of the claims of the present disclosure and their technical equivalents, then the present disclosure is intended to encompass such modifications and variations as well.

What is claimed is:

1. A method for game live-streaming, applied to a live-streaming server, comprising:
receiving a collaborative gaming request from a live-streaming account, the collaborative gaming request comprising:
a collaborative account selected by the live-streaming account from one or more audience accounts for collaborative gaming, and
a collaborative game selected by the live-streaming account from one or more candidate games;
invoking a cloud game service process to start the collaborative game and synchronize the collaborative game to a live-streaming interface;
receiving a first game operation instruction from the live-streaming account, and invoking the cloud game service process to update a video stream of the collaborative game to a live-streaming interface of the live-streaming account and a live-streaming interface of a non-collaborative account of the one or more audience accounts; and
receiving a second game operation instruction from the collaborative account, and invoking the cloud game service process to update a video stream of the collaborative game to a live-streaming interface of the collaborative account.

2. The method of claim 1, further comprising:
receiving a game close instruction from the live-streaming account, releasing the invoked cloud game service process, and displaying a live-streaming interface of the one or more candidate games; or
receiving, from the live-streaming account, an instruction to stop collaborative gaming with the collaborative account, and updating the collaborative account as a non-collaborative account.

3. The method of claim 1, further comprising:
displaying a live-streaming interface of the one or more candidate games in response to receiving a live-streaming request from the live-streaming account; and
displaying information of an audience account on the live-streaming interface in response to receiving a request for watching the live-streaming from the audience account.

4. The method of claim 1, further comprising:
obtaining a screening condition from the live-streaming account, wherein the screening condition is configured for screening out the collaborative account;
screening out at least one candidate audience account matching the screening condition from the one or more audience accounts; and
displaying, on the live-streaming interface, any of the at least one candidate audience account as a candidate collaborative account in response to receiving a collaborative gaming request from the any of the at least one candidate audience account, to enable the live-streaming account to determine the collaborative account from the candidate collaborative account.

5. The method of claim 4, wherein the screening condition comprises any one or more of:
a degree of an audience account's interest in the live-streaming account being greater than a predetermined value;
an electronic trading behavior of an audience account complying with an electronic trading rule established by the live-streaming account;
a game account classification of an audience account belonging to a game account classification of the collaborative game selected by the live-streaming account.

6. The method of claim 4, wherein said obtaining the screening condition from the live-streaming account, comprises:
receiving a setting request from the live-streaming account, and displaying setting options for the screening condition on the live-streaming interface in response to the setting request; and
receiving, from the live-streaming account, editing information for the setting options, and generating the screening condition based on the editing information.

7. The method of claim 4, wherein said receiving the collaborative gaming request from the any of the at least one candidate audience account, comprises:
displaying a trigger icon corresponding to the collaborative gaming request on a live-streaming interface of the candidate audience account; and
receiving the collaborative gaming request from the candidate audience account upon operation on the trigger icon.

8. The method of claim 1, further comprising:
recording operation information of the live-streaming account and the collaborative account for collaborative gaming based on the invoking the cloud game service process,
wherein the operation information comprises: time to start the collaborative game, time to end the collaborative game, and a reason to end the collaborative game.

9. The method of claim 1, further comprising:
establishing a voice connection between the live-streaming account and the collaborative account in response to receiving the collaborative gaming request from the live-streaming account.

10. A device for game live-streaming, comprising:
a memory configured to store a computer program; and
a processor configured to read the computer program stored in the memory and to:
receive a collaborative gaming request from a live-streaming account, the collaborative gaming request comprising:
a collaborative account selected by the live-streaming account from one or more audience accounts for collaborative gaming, and
a collaborative game selected by the live-streaming account from one or more candidate games;
invoke a cloud game service process to start the collaborative game and synchronize the collaborative game to a live-streaming interface;
receive a first game operation instruction from the live-streaming account, and invoking the cloud game service process to update a video stream of the collaborative game to a live-streaming interface of the live-streaming account and a live-streaming interface of a non-collaborative account of the one or more audience accounts; and
receive a second game operation instruction from the collaborative account, and invoking the cloud game service process to update a video stream of the collaborative game to a live-streaming interface of the collaborative account.

11. The device of claim 10, wherein the processor is further configured to:
receive a game close instruction from the live-streaming account, release the invoked cloud game service process, and display a live-streaming interface of the one or more candidate games; or
receive, from the live-streaming account, an instruction to stop collaborative gaming with the collaborative account, and update the collaborative account as a non-collaborative account.

12. The device of claim 10, wherein the processor is further configured to:
display a live-streaming interface of the one or more candidate games in response to receiving a live-streaming request from the live-streaming account; and
display information of an audience account on the live-streaming interface in response to receiving a request for watching the live-streaming from the audience account.

13. The device of claim 10, wherein the processor is further configured to:
obtain a screening condition from the live-streaming account, wherein the screening condition is configured for screening out the collaborative account;
screen out at least one candidate audience account matching the screening condition from the one or more audience accounts; and
display, on the live-streaming interface, any of the at least one candidate audience account as a candidate collaborative account in response to receiving a collaborative gaming request from the any of the at least one candidate audience account, to enable the live-streaming account to determine the collaborative account from the candidate collaborative account.

14. The device of claim 13, wherein the screening condition comprises any one or more of:
a degree of an audience account's interest in the live-streaming account being greater than a predetermined value;
an electronic trading behavior of an audience account complying with an electronic trading rule established by the live-streaming account;
a game account classification of an audience account belonging to a game account classification of the collaborative game selected by the live-streaming account.

15. The device of claim 13, wherein the processor is configured to obtain the screening condition from the live-streaming account by:
receiving a setting request from the live-streaming account, and displaying setting options for the screening condition on the live-streaming interface in response to the setting request; and
receiving, from the live-streaming account, editing information for the setting options, and generating the screen condition based on the editing information.

16. The device of claim 13, wherein the processor is configured to receive the collaborative gaming request from the any of the at least one candidate audience account by:
displaying a trigger icon corresponding to the collaborative gaming request on a live-streaming interface of the candidate audience account; and
receiving the collaborative gaming request from the candidate audience account upon operation on the trigger icon.

17. The device of claim 10, wherein the processor is further configured to:
record operation information of the live-streaming account and the collaborative account for collaborative gaming based on the invoking the cloud game service process,
wherein the operation information comprises: time to start the collaborative game, time to end the collaborative game, and a reason to end the collaborative game.

18. The device of claim 10, wherein the processor is further configured to:
establish a voice connection between the live-streaming account and the collaborative account in response to receiving the collaborative gaming request from the live-streaming account.

19. A non-transitory computer storage medium, stored thereon with a computer program that, when executed by a processor, cause the processor to:
receive a collaborative gaming request from a live-streaming account, the collaborative gaming request comprising:
a collaborative account selected by the live-streaming account from one or more audience accounts for collaborative gaming, and
a collaborative game selected by the live-streaming account from one or more candidate games;
invoke a cloud game service process to start the collaborative game and synchronize the collaborative game to a live-streaming interface;
receive a first game operation instruction from the live-streaming account, and invoking the cloud game service process to update a video stream of the collaborative game to a live-streaming interface of the live-streaming account and a live-streaming interface of a non-collaborative account of the one or more audience accounts; and
receive a second game operation instruction from the collaborative account, and invoking the cloud game service process to update a video stream of the collaborative game to a live-streaming interface of the collaborative account.
